(19) United States
(12) Patent Application Publication
(10) Pub. No.: US 2025/0004708 A1
(43) Pub. Date: Jan. 2, 2025

(54) DISPLAY DEVICE

(71) Applicant: LG ELECTRONICS INC., Seoul (KR)

(72) Inventors: Taejoon KIM, Seoul (KR); Jaekyung LEE, Seoul (KR)

(73) Assignee: LG ELECTRONICS INC., Seoul (KR)

(21) Appl. No.: 18/694,645

(22) PCT Filed: Oct. 21, 2021
(86) PCT No.: PCT/KR2021/014837

§ 371 Date: Mar. 22, 2024

(51) Int. Cl. G06F 3/16; H04N 21/422; H04N 21/439

(52) U.S. Cl. CPC G06F 3/167; H04N 21/42203; H04N 21/42222; H04N 21/4394

(57) ABSTRACT

A display device according to an embodiment of the present disclosure comprises: a display; an audio output unit; a voice acquisition unit that acquires a voice command; and a control unit that outputs a voice result according to the voice command through at least one of the display or the audio output unit, wherein, when a voice guidance function for the voice result is set to ON, the control unit may further output voice feedback for the voice result.

### TECHNICAL FIELD

The present disclosure relates to a display device.

### BACKGROUND ART

As voice recognition technology has developed, a user may control various electronic device such as TVs through voice, or specific information may be guided to the user through voice. Particularly, such a voice function may be more useful for the user having vision problems.

However, the current voice function has an disadvantage of simply receiving a voice command and outputting the results accordingly. Particularly, the results of the voice command are often provided visually, and thus, the user having the vision problems often has difficulty acquiring information. For example, in response to a voice command such as “Find a movie”, the display device may audibly output only “Movie search results. Which of these would you choose? If you move the key to the right, you can check other results”, and in many cases, it may only output an actual movie search results to visually display the results, and thus, there is a problem in which the user does not acquire information you want to get.

### DISCLOSURE OF THE INVENTION

### Technical Problem

The present disclosure provides a display device that facilitates acquisition of information and a voice control through voice by a user having vision problems.

The present disclosure provides a display device that facilitates an additional voice control when providing a voice result for a voice command.

### Technical Solution

A display device according to the present disclosure includes a display, an audio output unit, a sound acquisition unit configured to acquire a voice command, and a control unit configured to output voice results according to the voice command through at least one of the display or the audio output unit, wherein the control unit is configured to further output voice feedback for the voice results when a voice guidance function is set to be turned on.

The voice feedback may include a recommended query.

The control unit may be configured to further output the voice results and then outputs voice feedback that recommends any one of the voice results.

The control unit may be configured to output both the voice results and the voice feedback in a voice.

The control unit may be configured to output the voice results when the voice guidance function is set to be turned on differently from the voice results when the voice guidance function is set to be turned off.

The control unit may be configured to: output the voice result so that the current broadcast is listed as priority when the voice guidance function is set to be turned on; and output the voice results listed regardless of the current broadcast when the voice guidance function is set to be turned off.

The control unit may be configured to output a recommended query that expand a target range of the voice results through the voice feedback.

The control unit may be configured to an object of the voice results in order when acquiring a voice that utters the recommended query.

The control unit may be configured to execute the object at the time of utterance of the recommended query when a voice that utters the recommended query for selecting a specific object is acquired while outputting the object of the voice results in order.

The control unit may be configured to output the voice feedback in a page unit.

The control unit may be configured to output the voice feedback in the page unit in a manner in which all pieces of information on the current page are output, and then, information on the next page is output.

When the voice guidance function for the voice results is set to be turned on, the control unit may be configured to output movement of focus based on a signal received from a remote control device in a page unit.

The control unit may be configured to output at least one recommended query in a voice standby state for acquiring the voice command.

The control unit may be configured to output voice feedback for describing any one of the recommended query.

The control unit may be configured to acquire a command to set the voice guidance function to be turned on or off.

### Advantageous Effects

According to the embodiment of the present disclosure, there may be the advantage in that it is possible to control the display device using only the voice without having to look at the screen.

According to the embodiment of the present disclosure, there may be the advantage that it is easy to control the display device for the user having the vision problems.

### BRIEF DESCRIPTION OF THE DRAWINGS

FIG. 1 is a block diagram illustrating a configuration of a display device according to an embodiment of the present disclosure.

FIG. 2 is a block diagram illustrating a remote control device according to an embodiment of the present disclosure

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a flowchart illustrating an operation method of a display device according to a related art.

FIG. 6 is a flowchart illustrating an operation method of a display device according to an embodiment of the present disclosure.

FIG. 7 is a block diagram illustrating a configuration of the display device for providing a voice guidance function according to an embodiment of the present disclosure.

FIG. 8 is a view illustrating an example of a method by which the display device outputs voice feedback that explains a recommended query according to an embodiment of the present disclosure.

FIG. 9 is a view illustrating a first example in which the display device outputs a voice result and voice feedback according to an embodiment of the present disclosure.

FIG. 10 is a view illustrating a second example in which the display device outputs a voice result and voice feedback according to an embodiment of the present disclosure.

FIG. 11 is a view illustrating a third example in which the display device outputs a voice result and voice feedback according to an embodiment of the present disclosure.

FIG. 12 is a view illustrating an example in which the display device outputs a voice result differently depending on setting of the voice guidance function according to an embodiment of the present disclosure.

FIG. 13 is a view for explaining a method for configuring and outputting voice feedback in a page unit by the display device according to an embodiment of the present disclosure.

### MODE FOR CARRYING OUT THE INVENTION

Hereinafter, embodiments relating to the present disclosure will be described in detail with reference to the accompanying drawings. The suffixes “module” and “unit” for components used in the description below are assigned or mixed in consideration of easiness in writing the specification and do not have distinctive meanings or roles by themselves.

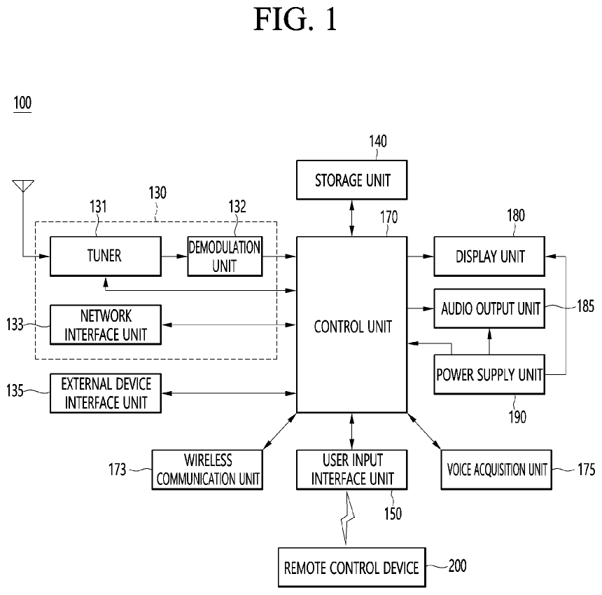

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output unit 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface unit 133 may access a predetermined webpage through an accessed network or another network linked to the accessed network. That is, the network interface unit 133 may transmit or receive data to or from a corresponding server by accessing a predetermined webpage through the network.

The network interface unit 133 may receive content or data provided from a content provider or a network operator. That is, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output unit 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not shown) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external device such as a camera or a camcorder, which are input through the external device interface unit 135, through the display unit 180 or the audio output unit 185, according to an external device image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform wired or wireless communication with an external device. The wireless communication unit 173 may perform short-range communication with an external device. For this, the wireless communication unit 173 may support short-range communication by using at least one of Bluetooth™ Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication unit 173. Therefore, a user of the wearable device may use the data processed by the display device 100 through the wearable device.

The voice acquisition unit 175 may acquire audio. The voice acquisition unit 175 may include at least one microphone (not shown) and may acquire audio around the display device 100 through the microphone (not shown).

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

The audio output unit 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display unit 180 for displaying an image, the audio output unit 185 for outputting audio, and the like.

Specifically, the power supply unit 190 may include a converter that converts AC power to DC power and a DC/DC converter that converts a level of the DC power.

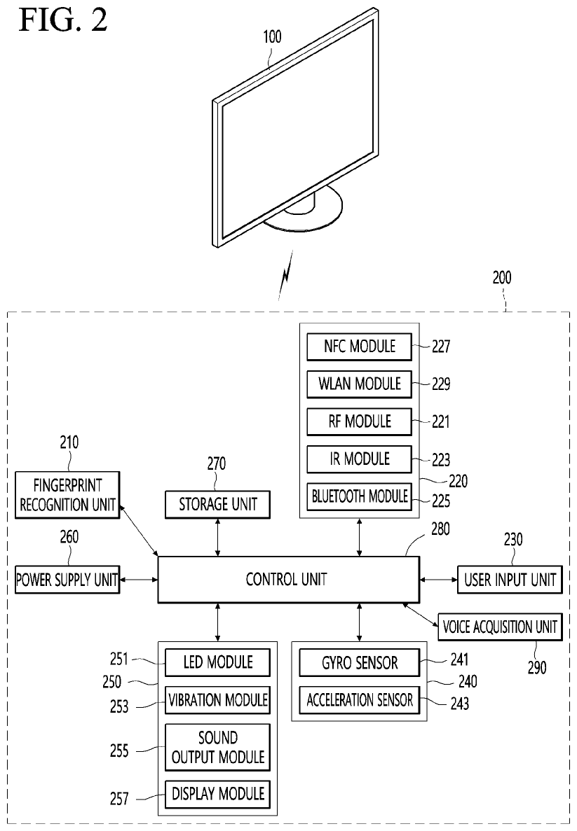

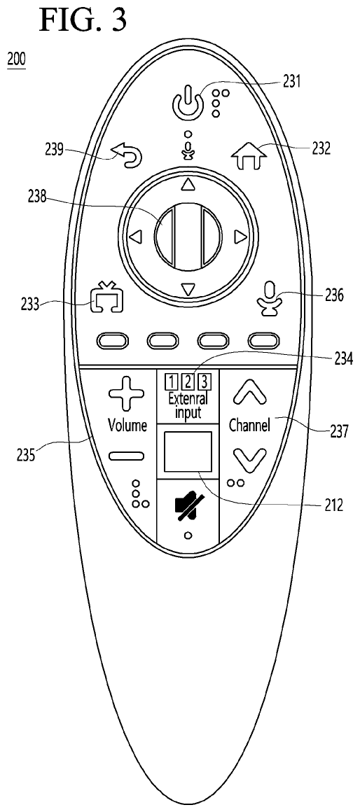

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication unit 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input unit 230, or may output image or voice signals corresponding to signals transmitted from the display device 100. A user may recognize whether the user input unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication unit 220.

In addition, the sound acquisition unit 290 of the remote control device 200 may acquire voice.

The sound acquisition unit 290 may include at least one microphone and acquire voice through the microphone.

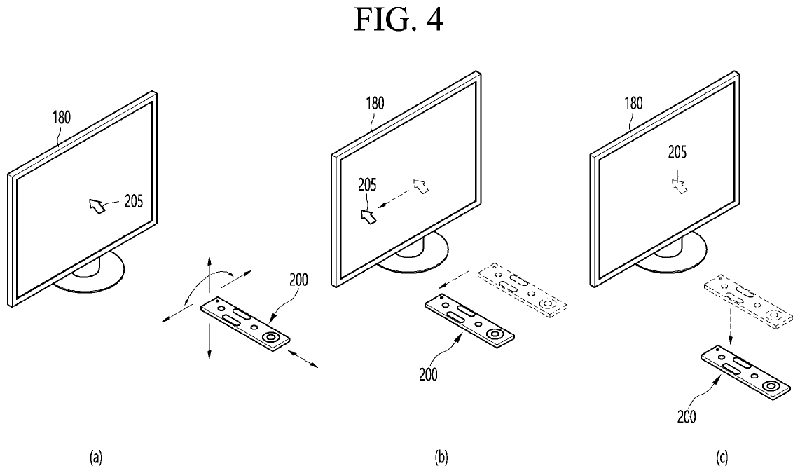

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

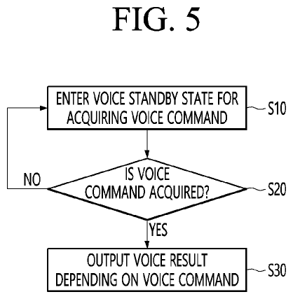

FIG. 5 is a flowchart illustrating an operation method of a display device according to a related art.

A display device according to a related art may enter a voice standby state to acquire a voice command (S10).

The display device according to the related art may display a recommended voice word in the voice standby state.

The display device according to the related art may determine whether a voice command is acquired in the voice standby state (S20).

If the display device according to the related art does not acquire the voice command, the voice standby state for acquiring the voice command may be maintained.

When the display device according to the related art acquires the voice command, a voice result according to the voice command may be output (S30).

As described above, since the display device according to the related art do not provide an auditory guidance function in the voice standby state, it is difficult for a user having vision problems such as the visually impaired or user who is unable to see a screen to recognize the voice standby state, or there is a limitation in not being provided with a recommended voice word. In addition, since the display device according to the related art only outputs the voice result according to the voice command when acquiring the voice command, the user having the vision problems or user who does not see the screen often have difficulty using the voice result.

Thus, the present disclosure intends to provide an additional function in an overall operation of acquiring the voice command and providing the result. The display device according to an embodiment of the present disclosure intends to further provide a voice guidance function. The display device according to an embodiment of the present disclosure intends to audibly guide visually provided information to the user.

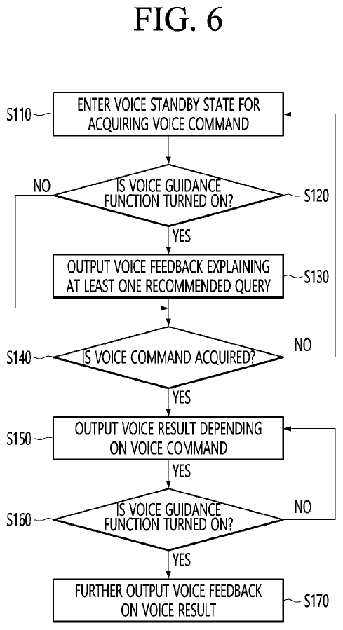

FIG. 6 is a flowchart illustrating an operation method of the display device according to an embodiment of the present disclosure.

A control unit 170 may enter a voice standby state to acquire a voice command (S110).

The control unit 170 may control a microphone (not shown) to be turned on in the voice standby state.

The control unit 170 may acquire audio through a microphone (not shown) in the voice standby state to extract and recognize a user's voice, that is, the user's voice, from the acquired audio.

The voice may represent sound in a broad sense and represent a human voice in a narrow sense. In this specification, unless otherwise stated, the voice refers to the human voice.

The control unit 170 may determine whether the voice guidance function is turned on in the voice standby state (S120).

When entering the voice standby state, the control unit 170 may acquire whether the voice guidance function is turned on. The control unit 170 may acquire whether the voice guidance function is set in the voice standby state.

The voice guidance function may refer to a function that audibly provides guidance information when performing an operation related to the voice command.

The control unit 170 may set whether the voice guidance function is turned on or off. The control unit 170 may acquire a command to set the voice guidance function to be turned on or off. Specifically, the control unit 170 may receive an input for turning on or off the voice guidance function through a user input interface unit 150 and may set the voice guidance function to be turned on or off according to the received input.

When the voice guidance function is turned on, the control unit 170 may audibly provide the guidance information related to the voice command.

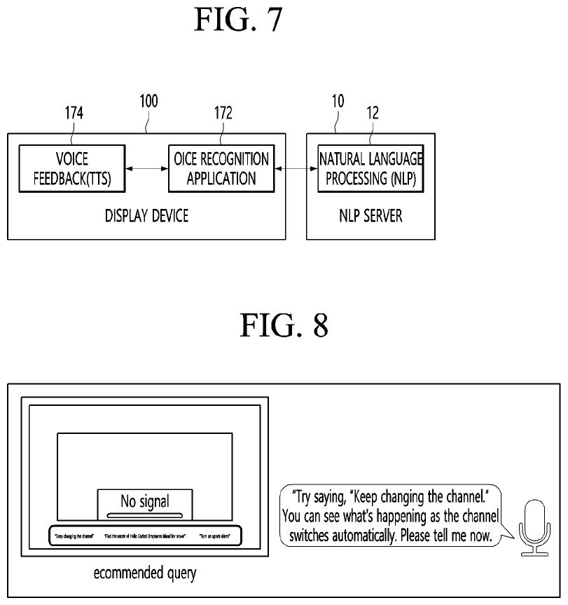

FIG. 7 is a block diagram illustrating a configuration of the display device for providing the voice guidance function according to an embodiment of the present disclosure.

A voice recognition application 172 may be installed in the display device 100 and may communicate with an NLP server 10 through the voice recognition application 172. The voice recognition application 172 may recognize the user's voice to acquire the intention of the user's voice through the communication with the NLP server 10. The NLP server 10 may include a natural language processing (NLP) module 12, and the natural language processing module 120 may analyze and process the user's voice.

A voice feedback (TTS) module 174 may convert the guidance information in the form of text into a voice so that the guidance information according to the intention of the user's voice is audibly output.

That is, the control unit 170 may analyze the intention of the user's voice through the voice recognition application 172 and control the voice feedback module 174 so that the guidance information related to the voice result according to the intention is output as the voice.

The voice recognition application 172 and the voice feedback module 174 are merely configurations for convenience of explanation, and are not limited thereto.

Again, FIG. 6 will be described.

When the voice guidance function is turned off, the control unit 170 may determine whether the voice command is acquired. That is, when the voice guidance function is not turned on, the control unit 170 may determine whether the voice command is acquired.

When the voice guidance function is turned on, the control unit 170 may output voice feedback explaining at least one recommended query (S130).

When the voice guidance function is turned on, the control unit 170 may audibly output a recommended query through the voice feedback. The control unit 170 may output at least one recommended query in the voice standby state for acquiring the voice command. The control unit 170 may output voice feedback explaining one of the recommended queries.

The control unit 170 may control a display unit 180 to display the recommended queries in the voice standby state and control an audio output unit 185 to output the voice feedback explaining at least one of the displayed recommended queries. That is, the voice feedback may include a recommended query.

The recommended query may mean a recommended voice command. The control unit 170 may provide different recommended queries depending on the situation. For example, the control unit 170 may provide different recommended queries based on various situations such as a current channel, a current content, a current time, a currently popular search term, a voice command, etc.

The voice feedback may be guidance information provided in response to the voice standby state, the voice command, or the voice result and may particularly refer to guidance information that is output audibly.

FIG. 8 is a view illustrating an example of a method by which the display device outputs voice feedback that explains the recommended query according to an embodiment of the present disclosure.

Referring to the example of FIG. 8, the control unit 170 may control the display unit 180 so that a first query (“Keep changing the channel”), a second query (“Find the secret of Hello Carbot Movie Ompharos Island”), and a third query (“Turn on sports alarm”) are disposed as recommended queries.

The first to third queries may be recommended queries determined by the current situation. An example of a method for acquiring the recommended query is as follows. When the channel is changed more than a preset number of times during a predetermined period of time immediately before entering the voice standby state, the control unit 170 may acquire the first query related to the channel change as the recommended query. The control unit 170 may acquire the second query that searches for the content similar to the content being displayed in the voice standby state as the recommended query. The control unit 170 may acquire the third query about the channel, the content, or the setting related to the channel when entering the voice standby state as the recommended query.

The control unit 170 may control the audio output unit 185 to output the voice feedback for at least one of the first to third queries. Referring to the example of FIG. 8, the control unit 170 may output “Try saying, “Keep changing the channel.” You can see what's happening as the channel switches automatically. “Please tell me now.” as the voice feedback explaining the first query. That is, the control unit 170 may output the first query itself and a description of the first query as the voice feedback.

In this case, there is an advantage in that the difficulty in which the user who does not see the screen does not recognize the recommended query when the recommended query, which is provided differently depending on the situation, is provided only visually is resolved.

Again, FIG. 6 will be described.

The control unit 170 may determine whether the voice command is acquired (S140).

That is, the control unit 170 may determine whether the voice command is acquired in the voice standby state. The control unit 170 may determine whether the voice command has been acquired.

When the control unit 170 does not acquire the voice command, the voice standby state may be maintained.

When the control unit 170 acquires the voice command, a voice result according to the voice command may be output (S150). After outputting the voice result, the control unit 170 may acquire whether the voice guidance function is turned on (S160), and when the voice guidance function is turned on, voice feedback about the voice result may be further output (S170).

The control unit 170 may output each of the audio result and the audio feedback using at least one of the display unit 180 or the audio output unit 185. The control unit 170 may output both the voice result and the voice feedback as a voice through at least the audio output unit 185.

The control unit 170 may output the voice result according to the voice command through at least one of the display unit 180 or the audio output unit 185.

When the voice guidance function is turned off, the control unit 170 may finish an operation of the voice command by outputting the voice result. That is, the control unit 170 may not output the voice feedback when the voice guidance function is turned off.

When the voice guidance function is set to be turned on, the control unit 170 may further output the voice feedback regarding the voice result.

Next, a method of the control unit 170 further outputting the voice feedback after outputting the voice result will be described.

After outputting the voice results, the control unit 170 may further output the voice feedback recommending one of the voice results.

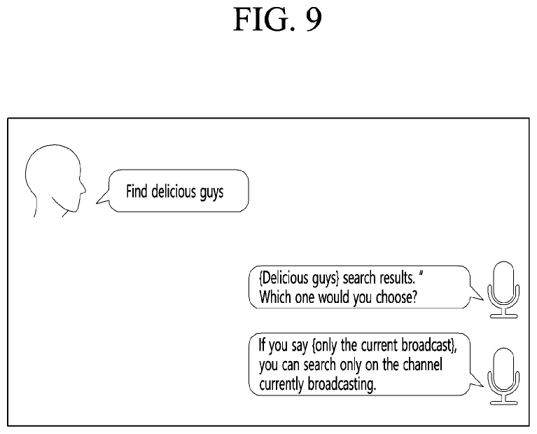

FIG. 9 is a view illustrating a first example in which the display device outputs the voice result and the voice feedback according to an embodiment of the present disclosure.

Referring to the example of FIG. 9, when the control unit 170 acquires a voice command (for example, “Find delicious guys”) to search for a specific program, information about the specific program searched as a voice result corresponding to the voice command may be output through at least one of the display unit 180 or the audio output unit 185. In the example of FIG. 9, the control unit 170 may output “{Delicious guys} search results. “Which one would you choose?” through the audio output unit 185 to provide the voice result while displaying the specific program searched through the display unit 180. When the display device according to the related art or the voice guidance function is turned off, the operation of the voice command may be terminated by providing the voice result. However, when the voice guidance function is turned on, the control unit 170 may output the voice feedback explaining the extended function for the provided voice result as the voice feedback for the voice result. For example, the control unit 170 may control the audio output unit 185 to further output “If you say {only the current broadcast}, you can search only on the channel currently broadcasting.”

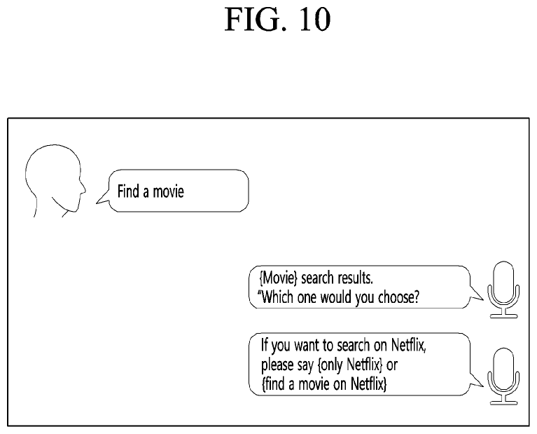

FIG. 10 is a view illustrating a second example in which the display device outputs the voice result and the voice feedback according to an embodiment of the present disclosure.

Referring to the example of FIG. 10, when the control unit 170 acquires a voice command (for example, “Find a movie”) to search for a specific genre, Information about the content searched as a voice result corresponding to the voice command may be output through at least one of the display unit 180 or the audio output unit 185. In the example of FIG. 10, the control unit 170 may output “{Movie} search results. “Which one would you choose?” through the audio output unit 185 to provide the voice result while displaying at least one content searched through the display unit 180. When the display device according to the related art or the voice guidance function is turned off, the operation of the voice command may be terminated by providing the voice result. However, when the voice guidance function is turned on, the control unit 170 may output the voice feedback explaining the extended function for the provided voice result as the voice feedback for the voice result. For example, the control unit 170 may control the audio output unit 185 to further output “If you want to search on Netflix, please say {only Netflix} or {find a movie on Netflix}.”

That is, as shown in the examples of FIGS. 9 and 10, the control unit 170 may output voice feedback including a recommended query. The control unit 170 may output the voice feedback guiding the recommended query according to the voice result. The control unit 170 may provide the recommended query to the voice feedback. The control unit 170 may randomly select at least one of the recommended queries (e.g., “the current broadcast among them, “only Netflix among them”, “find a movie in Netflix”) provided according to the voice result to provides the selected query to the voice feedback.

In addition, after outputting the voice result, the control unit 170 may output the voice feedback guiding how to narrow a range of the voice result.

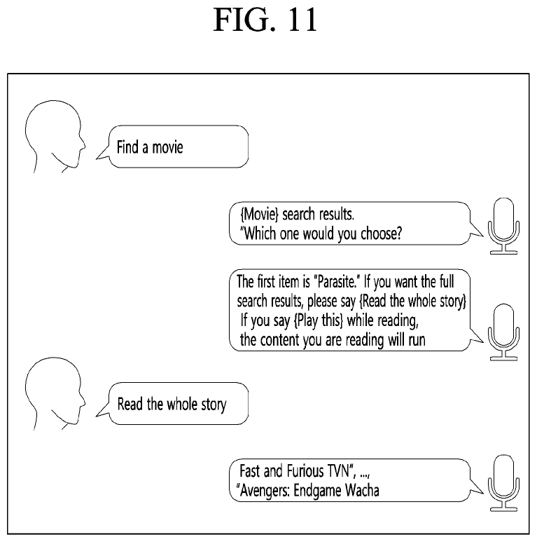

FIG. 11 is a view illustrating a third example in which the display device outputs the voice result and the voice feedback according to an embodiment of the present disclosure.

Referring to the example of FIG. 11, when the control unit 170 acquires a voice command (for example, “Find a movie”) to search for a specific genre, Information about the content searched as a voice result corresponding to the voice command may be output through at least one of the display unit 180 or the audio output unit 185. In the example of FIG. 11, the control unit 170 may output “{Movie} search results. “Which one would you choose?” through the audio output unit 185 to provide the voice result while displaying information about the content searched through the display unit 180. When the display device according to the related art or the voice guidance function is turned off, the operation of the voice command may be terminated by providing the voice result. However, when the voice guidance function is turned on, the control unit 170 may output the voice feedback explaining the extended function for the provided voice result as the voice feedback for the voice result. For example, the control unit 170 may control the audio output unit 185 to further output “The first item is “Parasite.” If you want the full search results, please say {Read the whole story}. If you say {Play this} while reading, the content you are reading will run.” In the example above, “Read the whole story” may be a recommendation query that expands a target range of the audio result, and “Play this” may be a recommendation query that selects a target of the audio result.

The control unit 170 may maintain the voice standby state while outputting the voice feedback. If the control unit 170 acquires the recommended query guided in the voice feedback while outputting the voice feedback or after outputting the voice feedback, an operation according to the recommended query may be performed. When the control unit 170 acquires a voice command for uttering the recommendation query that expands the target range of the voice result, the target of the voice result may be output in order. For example, when the control unit 170 acquires a recommended query (e.g., “Read the whole story”) guided by the voice feedback as the voice command, an operation according to the voice feedback such as “Parasite OCN”, “Fast and Furious TVN”, . . . , “Avengers: Endgame Wacha” may be performed. In addition, if the control unit 170 acquires a voice command for uttering a recommendation query for selecting a specific object while outputting the objects of the voice result in order, the object may be executed at a point of utterance of the recommendation query.

As in the example of FIG. 11, after outputting the voice result, the control unit 170 may output the voice feedback guiding how to expand a range of the voice result. That is, the control unit 170 may be configured to output a recommended query that expand a target range of the voice results through the voice feedback. For example, the control unit 170 may support analysis of the intention of the voice command such as “Read the whole story,” and thus, the target range of the voice feedback may be expanded to the entire range.

In addition, as shown in the examples of FIGS. 8 to 11, the control unit 170 may output voice feedback including a specific recommended query that executes an extended function for the voice result. As a result, the display device 100 has an advantage of being able to guide an additional expansion function for the voice result even to users who does not see the screen.

The control unit 170 may output the voice result when the voice guidance function is turned on and output a result different from the voice result when the voice guidance function is turned off.

According to an embodiment, when the voice guidance function is turned off, the control unit 170 may output a voice result in which a plurality of contents are disposed according to default settings (e.g., order of relevance). When the voice guidance function is turned on, the control unit 170 may output a voice result in which a content currently being broadcast is disposed in priority. When the voice guidance function is set to be turned on, the control unit 170 may output the voice result so that the current broadcast is listed first. When the voice guidance function is set to be turned off, the control unit 170 may output the voice result that is listed regardless of the current broadcast. That is, even if the output content is the same, the control unit 170 may output the voice result by disposing the content differently depending on whether the voice guidance function is turned on or off.

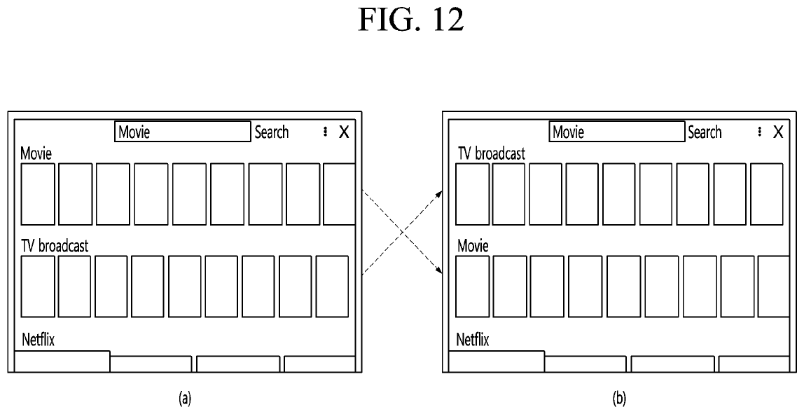

FIG. 12 is a view illustrating an example in which the display device outputs the voice result differently depending on setting of the voice guidance function according to an embodiment of the present disclosure.

(a) of FIG. 12 illustrates an example of an output of a plurality of contents when the voice guidance function is turned off, and (b) of FIG. 12 illustrates an example of an output of a plurality of contents when the voice guidance function is turned on.

As illustrated in (a) of FIG. 12, when the voice guidance function is turned off, the control unit 170 may dispose the plurality of contents in order of the movie and the TV broadcast. As illustrated in (b) of FIG. 12, when the voice guidance function is turned on, the control unit 170 may dispose a plurality of contents in order of the TV broadcast and the movie.

The control unit 170 may configure and output the voice feedback in a page unit. Specifically, after outputting the voice result, the control unit 170 may output information about the voice result in the page unit as the voice feedback. The control unit 170 may configure and output voice feedback in the page unit by outputting all pieces of information about the current page and then outputting information about the next page.

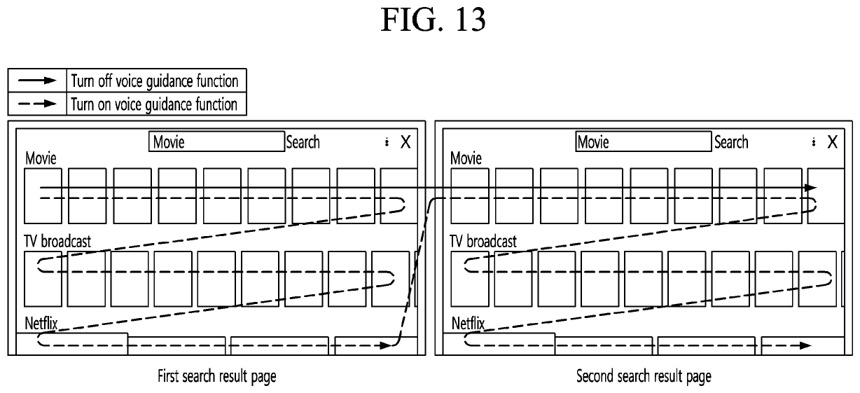

FIG. 13 is a view for explaining a method for configuring and outputting the voice feedback in the page unit by the display device according to an embodiment of the present disclosure.

The display device according to the related art may output a plurality of contents as the audio result and then outputs audio only for the currently focused content when a request for information about the contents is received.

However, after outputting the plurality of contents as the voice result, the control unit 170 of the display device 100 according to an embodiment of the present disclosure may output the information about all currently displayed contents as a voice when receiving a request for the information about the content, especially the voice command such as “Read the whole story”. The control unit 170 may output the information about all the contents within the current page and then move to the next page to output the information about all the contents within the next page. That is, the control unit 170 may configure items of the voice feedback provided as the result of the voice recognition function in a voice recognition result page unit. When the control unit 170 acquires the voice command such as “Read the whole story,” all the items on the first page are output in voice regardless of category (movies, TV broadcasts, Netflix). Thereafter, if there are no additional voice command, all the items on the second page may be output by the voice along with the page transition to the second page.

In addition, when outputting the information about all the content in voice, the control unit 170 may output the information about all the content in the current page in order by the voice without distinguishing categories.

In addition, when the voice guidance function for the voice result is set to be turned on, the control unit 170 may configure and output movement of a focus based on a signal received from a remote control device 200 in the page unit.

Specifically, when the voice guidance function is set to be turned off, the control unit 170 may move the focus according to a content movement command within the same category. That is, the control unit 170 may move the focus within the same category when the voice guidance function is turned off. Referring to FIG. 13, when the voice guidance function is turned off, the control unit 170 may not move the focus downward when the movement of the focus within the contents disposed at the uppermost side is completed, but move the focus to the contents of the next page within the same category. That is, when the voice guidance function is turned off, and a command for right movement is received in a state in which the focus is disposed at the uppermost right content, the control unit 170 may move the focus to the first content on the next page.

When the voice guidance function is set to be turned on, the control unit 170 may move the focus within the same page without distinguishing the categories when receiving the content movement command. When the control unit 170 receives a direction key input signal from the remote control device 200, the movement of the focus that specifies the content may be performed in the page unit. Specifically, the control unit 170 may move the focus within the content disposed at the uppermost side, and when the focus moves to an end within the content disposed at the uppermost side, the focus may move downward regardless of the category. The control unit 170 may move the focus to all the contents in the current page and then move to the next page so as to sequentially move the focus to all the contents in the next page. That is, the control unit 170 may move the focus to the end of the current category of the current page and then move the focus to the first item of the subcategory. When the voice guidance function is turned on, if a command for the right movement is received in the state in which the focus is disposed at the uppermost right content, the control unit 170 may move the focus to the leftmost content of another category disposed below. The control unit 170 may scroll the page or scroll all the items in the category depending on the turn-on state of the voice guidance function.

As described above, according to an embodiment of the present disclosure, the control unit 170 of the display device 100 may configure the item of the voice feedback and perform each operation according to the direction key input of the remote control device 200 in the page unit.

As described above, the control unit 170 of the display device 100 according to an embodiment of the present disclosure may provide different audio results or additionally provide the audio feedback depending on the set state of the voice guidance function.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices. In addition, the computer may include the control unit 170 of the display device 100. Thus, the detailed description is intended to be illustrative, but not limiting in all aspects. It is intended that the scope of the present invention should be determined by the rational interpretation of the claims as set forth, and the modifications and variations of the present invention come within the scope of the appended claims and their equivalents.

The above-disclosed subject matter is to be considered illustrative, and not restrictive, and the appended claims are intended to cover all such modifications, enhancements, and other embodiments, which fall within the true spirit and scope of the present invention.

Thus, the embodiment of the present invention is to be considered illustrative, and not restrictive, and the technical spirit of the present invention is not limited to the foregoing embodiment.

Therefore, the scope of the present invention is defined not by the detailed description of the invention but by the appended claims, and all differences within the scope will be construed as being comprised in the present invention.

What is claimed is:

1. A display device comprising:
a display;
an audio output unit;
a sound acquisition unit configured to acquire a voice command; and
a control unit configured to output voice results according to the voice command through at least one of the display or the audio output unit,
wherein the control unit is configured to further output voice feedback for the voice results when a voice guidance function is set to be turned on.

2. The display device according to claim 1, wherein the voice feedback comprises a recommended query.

3. The display device according to claim 1, wherein the control unit is configured to further output the voice results and then outputs voice feedback that recommends any one of the voice results.

4. The display device according to claim 3, wherein the control unit is configured to output both the voice results and the voice feedback in a voice.

5. The display device according to claim 1, wherein the control unit is configured to output the voice results when the voice guidance function is set to be turned on differently from the voice results when the voice guidance function is set to be turned off.

6. The display device according to claim 5, wherein the control unit is configured to:
output the voice result so that the current broadcast is listed as priority when the voice guidance function is set to be turned on; and
output the voice results listed regardless of the current broadcast when the voice guidance function is set to be turned off.

7. The display device according to claim 1, wherein the control unit is configured to output a recommended query that expand a target range of the voice results through the voice feedback.

8. The display device according to claim 7, wherein the control unit is configured to an object of the voice results in order when acquiring a voice that utters the recommended query.

9. The display device according to claim 8, wherein the control unit is configured to execute the object at the time of utterance of the recommended query when a voice that utters the recommended query for selecting a specific object is acquired while outputting the object of the voice results in order.

10. The display device according to claim 1, wherein the control unit is configured to output the voice feedback in a page unit.

11. The display device according to claim 1, wherein the control unit is configured to output the voice feedback in the page unit in a manner in which all pieces of information on the current page are output, and then, information on the next page is output.

12. The display device according to claim 1, wherein, when the voice guidance function for the voice results is set to be turned on, the control unit is configured to output movement of focus based on a signal received from a remote control device in a page unit.

13. The display device according to claim 1, wherein the control unit is configured to output at least one recommended query in a voice standby state for acquiring the voice command.

14. The display device according to claim 13, wherein the control unit is configured to output voice feedback for describing any one of the recommended query.

15. The display device according to claim 1, wherein the control unit is configured to acquire a command to set the voice guidance function to be turned on or off.
